(19) United States
(12) Patent Application Publication
(10) Pub. No.: US 2025/0246887 A1
(43) Pub. Date: Jul. 31, 2025

(54) REVERSIBLE OUTLET ADAPTER PLATE

(71) Applicant: Hubbell Incorporated, Shelton, CT (US)

(72) Inventors: Stephen Michael Boener, Goshen, IN (US); Jace Robert Lee Matteson, Granger, IN (US)

(21) Appl. No.: 19/037,709

(22) Filed: Jan. 27, 2025

Related U.S. Application Data
(60) Provisional application No. 63/624,985, filed on Jan. 25, 2024.

(51) Int. Cl. H02G 3/08; H02G 3/14

(52) U.S. Cl. CPC H02G 3/081; H02G 3/14

(57) ABSTRACT

An adapter plate for an electrical box includes a base having a base body with a first side and a second side. The base body defines an opening configured to receive an electrical device. The base includes a first snap-fit connector adjacent the opening. An insert includes an insert body configured to mate with the base. The insert body has a device opening and a second snap-fit connector configured to engage with the first snap-fit connector to releasably secure the insert to the base.

### RELATED APPLICATION(S)

This application is based on U.S. Provisional Application Ser. No. 63/624,985 filed Jan. 25, 2024, the disclosure of which is incorporated herein by reference in its entirety and to which priority is claimed.

### FIELD

Various exemplary embodiments relate to cover plates for electrical devices connected to a junction box.

### BACKGROUND

Electrical boxes are known for receiving electrical wiring for various wiring devices. The electrical boxes can stand alone or can be recessed in a wall, ceiling, floor, or other surface.

Electrical devices such as, but not limited to, electrical outlets, switches, buttons, communication ports, and others, are typically installed in a wall or ceiling. In indoor applications, an electrical box, also referred to as a gang or junction box, is secured to a stud or support beam inside of the wall or ceiling. In outdoor application, the electrical box can be installed in an opening or recess formed in an outer wall or in a free-standing support structure such as post. After the box is mounted, an electrical device is secured in the box in electrical communication with one or more electrical conductors. In this manner, any exposed portion of the electrical conductor and its connection to the electrical device can be shielded within the box.

In certain installations, a cover plate is placed around the electrical device to cover the outer edges of the device and the interior wiring of the electrical box. This provides a more decorative appearance and prevents inadvertent access to electrical wiring. Although standard sizes exist for certain categories of devices, different types of devices have different size requirements for cover plates. Accordingly, a different cover plate must be provided for each device. Some cover plates allow for multiple configurations by utilizing removal sections built into the cover plate with frangible connections such as score lines or perforations.

### SUMMARY

Certain implementations include an adapter plate for an electrical box.

Certain implementations include a reversible adapter plate for an electrical box.

Certain implementations include an adapter plate having a base and an insert snap-fit to the base.

In certain configurations an adapter plate for an electrical box includes a base having a base body with a first side and a second side. The base body defines an opening configured to receive an electrical device. The base includes a first snap-fit connector adjacent the opening. An insert includes an insert body configured to mate with the base. The insert body has a device opening and a second snap-fit connector configured to engage with the first snap-fit connector to releasably secure the insert to the base.

In certain configurations, an electrical box assembly includes a junction box having a rear wall and a plurality of side walls extending from the rear wall to define an interior. An electrical device is connected to the junction box. The electrical device is connected to a power supply by an electrical connection positioned inside the interior of the junction box. An adapter plate has a base and an insert, the base including a base body having a first, a second side, and an opening configured to receive an electrical device and the insert, and a first snap-fit connector configured to releasably connect the insert to the base. The insert includes an insert body configured to mate with the base. The insert body having a device opening and a second snap-fit connector configured to engage with the first snap-fit connector.

Certain configurations include an adapter plate for an electrical box. A base includes a base body having a first side, a second side, and a divider positioned between a first opening and a second opening. The base includes a first snap-fit connector adjacent the first opening and a second snap-fit connector adjacent the second opening. An insert includes an insert body configured to mate with the base, the insert body having a device opening and a third snap-fit connector configured to engage with the first snap-fit connector. The second side includes an upper recess and a lower recess configured to receive at least a portion of the insert.

Certain implementations are directed to a method of installing an electrical device. An electrical device is electrically connected to a power supply via an electrical connection. The electrical connection is positioned inside of a junction box. The electrical device is mechanically connected to the junction box. An insert configured for the electrical device is selected and the insert is connected to a base plate to form an adapter plate. The adapter plate is connected to the electrical device.

### BRIEF DESCRIPTION OF THE DRAWINGS

The following drawings depict exemplary configurations and implementations of the inventive concepts of the disclosure.

FIG. 1 is a front perspective view of a base of an adapter plate.

FIG. 2 is a rear perspective view of the base of FIG. 1.

FIG. 3 is an enlarged partial view of a snap-fit connector of FIG. 2.

FIG. 4 is a front perspective view of an outlet positioned in the base of FIG. 1.

FIG. 5 is a rear perspective view of 4.

FIG. 6 is a front perspective view of an insert for a duplex outlet.

FIG. 7 is a rear perspective view of FIG. 6.

FIG. 8 is an enlarged, partial view of a snap-fit connector of FIG. 6.

FIG. 9 is an enlarged, partial view of the snap-fit connector of the insert of FIG. 6 mated with the base.

FIG. 10 is a front view of the insert of FIG. 6 mated with the base.

FIG. 11 is a rear view of FIG. 10.

FIG. 12 is a front perspective view of an insert for a blank covering.

FIG. 13 is a rear perspective view of FIG. 12.

FIG. 14 is a front view of the insert of FIG. 12 mated with the base.

FIG. 15 is a rear view of FIG. 14.

FIG. 16 is a front perspective view of an insert for a two-button switch.

FIG. 17 is a rear perspective view of FIG. 16.

FIG. 18 is a front view of the insert of FIG. 16 mated with the base.

FIG. 19 is a rear view of FIG. 18.

FIG. 20 is a front perspective view of an insert for a keystone jack.

FIG. 21 is a rear perspective view of FIG. 20.

FIG. 22 is a front view of the insert of FIG. 20 mated with the base.

FIG. 23 is a rear view of FIG. 22.

FIG. 24 is a front perspective view of an insert for a dual keystone jack.

FIG. 25 is a rear perspective view of FIG. 24.

FIG. 26 is a front view of the insert of FIG. 24 mated with the base.

FIG. 27 is a rear view of FIG. 26.

FIG. 28 is a front perspective view of an insert for a Despard device.

FIG. 29 is a rear perspective view of FIG. 28.

FIG. 30 is a front view of the insert of FIG. 28 mated with the base.

FIG. 31 is a rear view of FIG. 30.

FIG. 32 is a front perspective view of an insert for a toggle switch.

FIG. 33 is a rear perspective view of FIG. 32.

FIG. 34 is a front view of the insert of FIG. 32 mated with the base.

FIG. 35 is a rear view of FIG. 34.

FIG. 36 is a front perspective view of a base of an adapter plate.

FIG. 37 is a rear perspective view of the base of FIG. 36.

FIG. 38 is a front perspective view of an insert for a duplex outlet.

FIG. 39 is a rear perspective view of FIG. 38.

FIG. 40 is a front perspective view of a two-gang base of an adapter plate.

FIG. 41 is a rear perspective view of the base of FIG. 40.

FIG. 42 is a front perspective view of an insert for a duplex outlet.

FIG. 43 is a rear perspective view of FIG. 42.

FIG. 44 is a front perspective view of an insert for a switch or flanged outlet.

FIG. 45 is a rear perspective view of FIG. 44.

FIG. 46 is a front perspective view of an insert for a flanged outlet.

FIG. 47 is a rear perspective view of FIG. 46.

### DETAILED DESCRIPTION

Various implementations are directed to an adaptable cover plate for an electrical device. The cover plate can include a base having an opening to receive an electrical device or to receive one of a plurality of inserts. The inserts are configured to conform to different electrical devices to provide an adaptable cover plate. The base can be reversible, having a first side configured to receive a first type of electrical device and a second side configured to receive a second type of electrical device. Different inserts can be used as needed to accommodate other electrical devices.

Typical electrical devices can include power outlets, switches, communication outlets, and sensors. Power outlets can include single gang or multi-gang configurations in standard outlets, tamper resistant outlets, and ground fault circuit interrupting (GFCI) outlets, USB outlets, pin and sleeve outlets. Different switches can include toggle switches, rocker switches, and push button switches. Communication outlets can include any data outlet such as telephone, coaxial cable, or an Ethernet port (RJ45). Sensors can include occupancy or daylight sensors such as passive infrared, ultrasonic, and photocell sensors.

Cover plates are used to surround the electrical device and enclose the electrical junction box. Cover plates can be connected to the junction box or the device depending on the configuration. Each type of electrical device can require different sized openings for a cover plate. Accordingly, a user can have a specific cover plate for each device. Alternatively, a user can have a cover plate with removable sections and form the required opening. Once the required opening is formed, however, a different configuration cannot be achieved. Both these solutions lack flexibility and reusability in different devices.

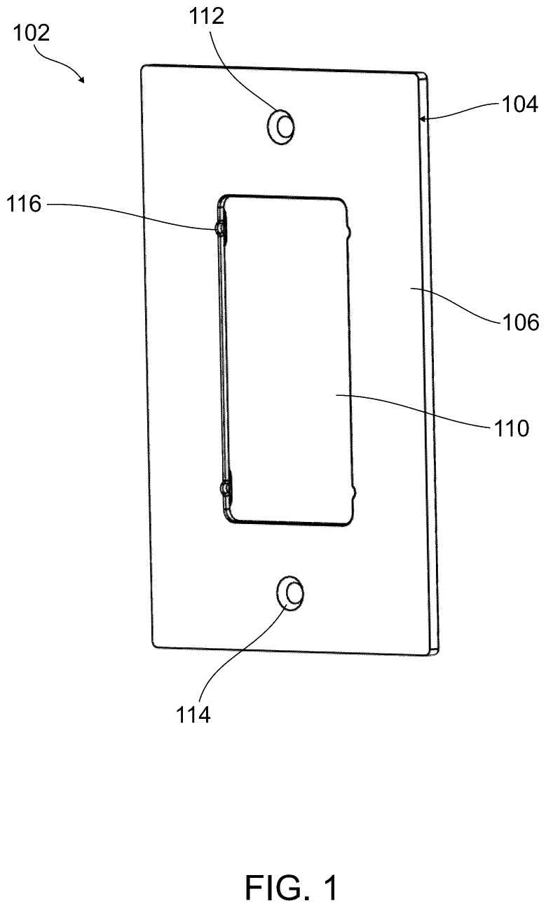

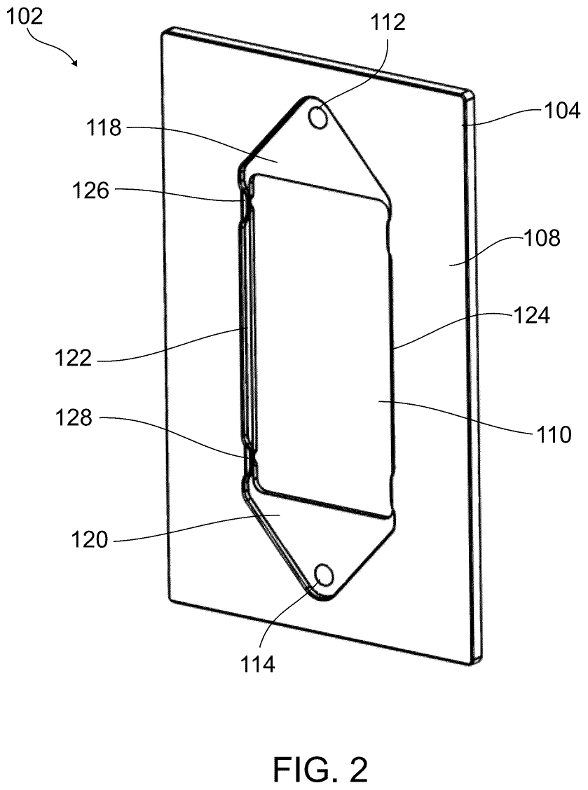

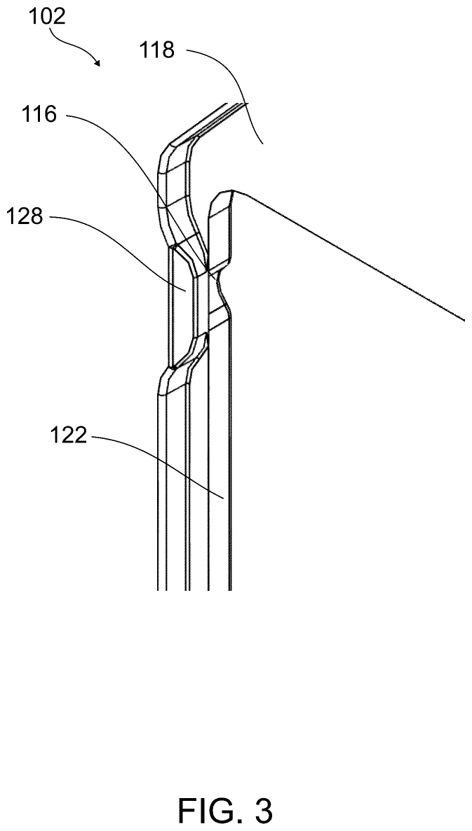

FIGS. 1 and 2 show an exemplary configuration of an adapter having a base plate 102 with a body 104 having a first side 106 and a second side 108. The body 104 has a substantially rectangular configuration that can be sized to fit into a standard single- gang junction box. The size and shape can be varied to accommodate other types of junction boxes, such as two-gang junction boxes, round junction boxes, or other junction boxes. A central opening 110 extends through the body 104 and provides space to receive an electrical device.

In certain configurations, the first side of the body has a substantially flush face surrounding the central opening 110. An upper fastener aperture 112 and a lower fastener aperture 114 extend through the body 102 on opposite side of the central opening 110. The fastener apertures 112, 114 can have a countersink configuration to accommodate a standard flat type screw head. From the first side 106, the central opening 110 is configured to receive a GFCI outlet.

The first side 106 of the body 104 around the central opening 110 can include one or more curved recesses 116. For example, two curved recess 116 can be provided on each long side of the opening 110, positioned toward the top and bottom of the opening 110.

In certain configurations, the second side 108 includes a substantially flush outer portion. An upper recessed area 118 and lower recessed area 120 and a pair of side recessed areas 122, 124 are formed around the central opening 110. The upper and lower recessed areas 118, 120 have angled sides with rounded corners, with the upper and lower corners being formed around the fastener apertures 112, 114. The side corners extend around the corners of the central opening 110. The side recessed areas 122, 124 extend between the upper and lower recessed areas 118, 120.

A set of upper tabs 126 and lower tabs 128 separate the side recessed areas 122, 124 from the upper and lower recessed areas 118, 120. The tabs 126, 128 and the curved recesses 116 form a snap-fit connection with a corresponding insert when connected to the base 102. Other snap fit structures can also be used, including various cantilever projections and mating components

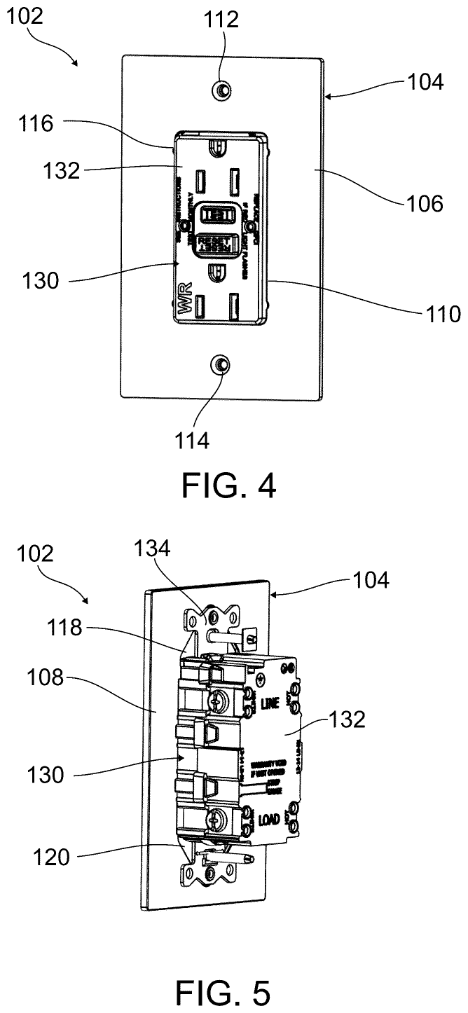

FIGS. 4 and 5, show an outlet 130 connected to the base 102. The outlet 130 is a GFCI outlet having an outer housing 132 with an upper set of receptacle openings and a lower set of receptacle openings. The outer housing 132 has a substantially rectangular configuration that fits within the central opening 110 of the base 102. A mounting strap 134 extends from the housing 132 having an upper strap portion and a lower strap portion. The upper and lower mounting strap portions are positioned on the second side 108 of the base 102. The outlet 130 can be connected to a junction box and the mounting strap 134 is configured to receive fasteners that extend through the fastener apertures 112, 114 to secure the base 102 to the outlet 130.

Various different inserts can be used in accordance with the base 102 to provide a cover plate for different electrical devices without having to remove or alter the base 102. A user can select one of a plurality of inserts to connect to the base 102, with the insert corresponding to a particular electrical device. A user may be provided with a plurality of inserts in a kit, or a single insert can be chosen and obtained separately with the base.

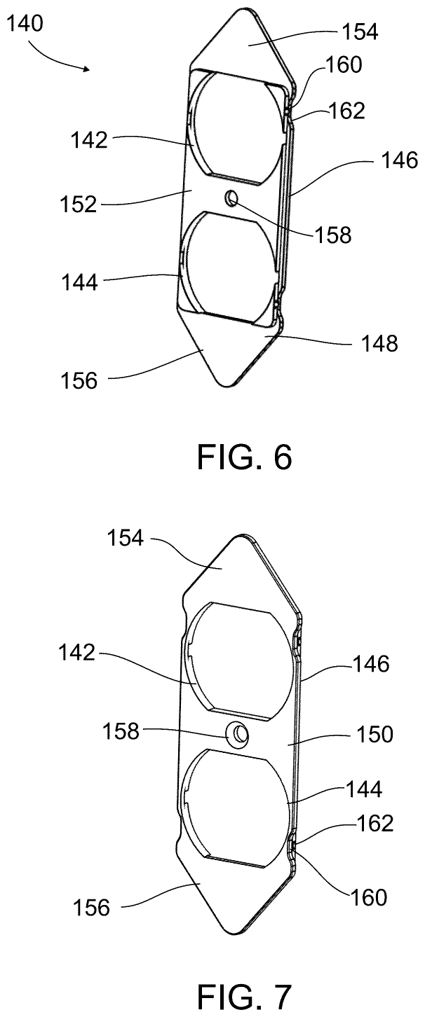

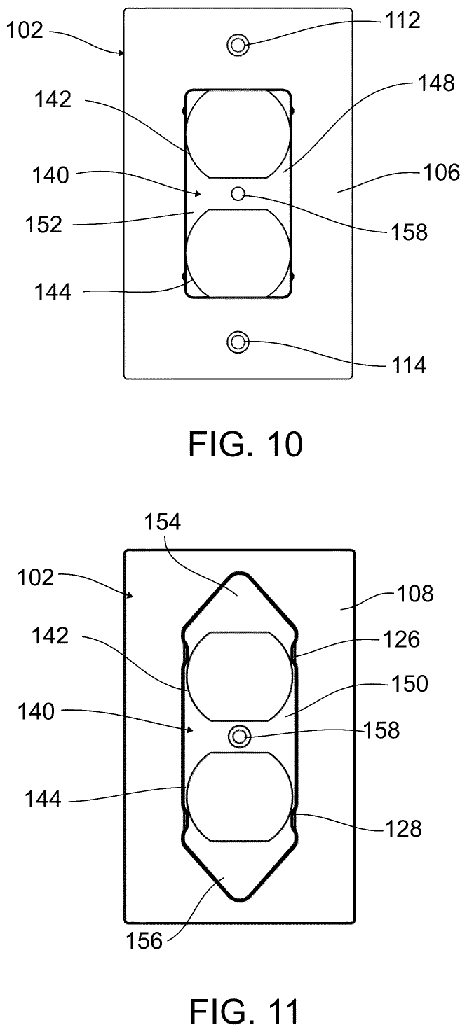

FIGS. 6-11 show an exemplary configuration of an insert 140 that is configured to provide a cover plate for a standard duplex outlet. Duplex outlets are commonly found in residential and commercial buildings and provide two separate receptacles or sockets for connecting electrical devices. Duplex outlets accommodate standard two-prong or three-prong plugs commonly used for various electrical appliances and devices. A typical duplex outlet has two vertical slots for prongs and a semicircular grounding hole. The left slot is smaller, designed for the hot wire, while the right slot is larger and accommodates the neutral wire. The grounding hole is for the grounding prong on three-prong plugs.

The insert 140 has upper and lower openings 142, 144 configured to receive the protruding receptacle faces of a standard duplex outlet. The insert 140 can be placed in the central opening 110 and snap-fit to the base 102. The insert 140 includes a body 146 with a first side 148 and a second side 150. When connected to the base 102, the first side 148 of the insert 140 faces the first side 106 of the base 102 and the second side 150 of the insert 140 faces the second side 108 of the base 102. The insert 140 and base 102 can then be positioned around a duplex outlet so that the second side 150 of the insert 140 and the second side 108 of the base 102 are positioned to face an exterior and the first sides 106, 148 face inwardly toward the junction box.

The first side 148 of the insert 140 includes a raised area 152 around the receptacle openings 142, 144. This raised area 152 extends through the central opening 110 of the base 102 so that the first side 148 of the insert 140 is substantially flush with the first side 106 of the base 102. The raised area 152 can include upper and lower raised corners on each side of the receptacle openings 142, 144 and a central raised area between the receptacle openings 142, 144.

The first side 148 and the second side 150 have an upper portion 154 and a lower portion 156 with a substantially planar outer surface. The upper portion 154 and lower portion 156 have angled sides with rounded corners that correspond to the upper and lower recessed areas 118, 120 of the base. A fastener aperture 158 is positioned between the upper and lower receptacle openings 142, 144 to receive a fastener to connect to a standard duplex receptacle. The fastener aperture 158 can be a counter-sink aperture on the second side 150 configured to receive a standard flat head fastener.

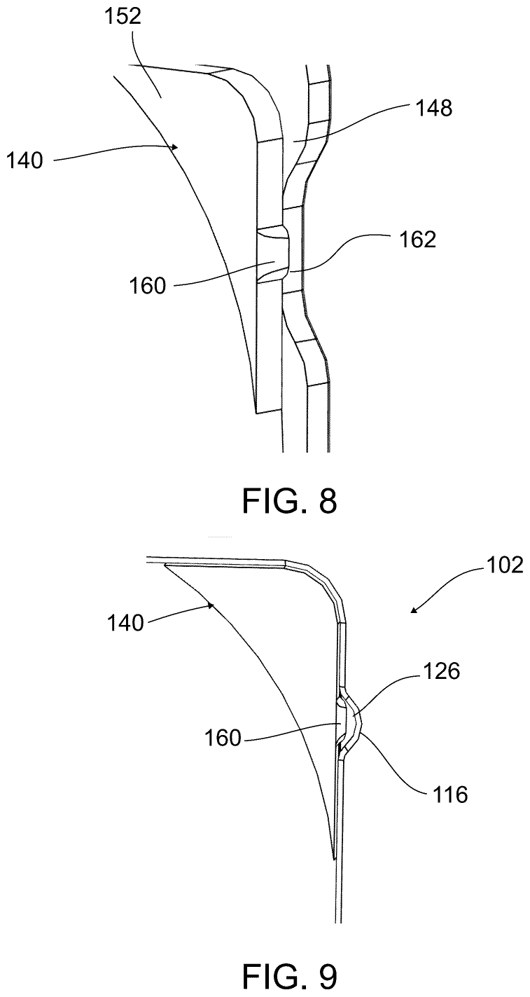

As best shown in FIG. 8, a set of protrusions 160 are formed on the first side 148 of the insert 140 and a set of indentations 162 are formed in the second side 150 of the insert 140 adjacent the protrusions 160. In the illustrated embodiment two upper and two lower sets of protrusions 160 and indentations 162 are used. The protrusions 160 and indentations 162 are configured to align with the curved recesses 116 and tabs 126, 128 on the base 102 to form a snap-fit connection. For example, as best shown in FIG. 9, the protrusions 160 can include an angled leading edge which can be pushed past the tabs 126, 128 and a trailing edge that clears and engages the tabs 126, 128 to resist removal of the insert 140. During installation, the insert 140 can be snap-fit to the base 102 and connected to an outlet so that the second side 108 of the base 102 and the second side 150 of the insert 140 face outwardly as shown in FIG. 11. Other snap fit structures can also be used, including various cantilever projections and mating components

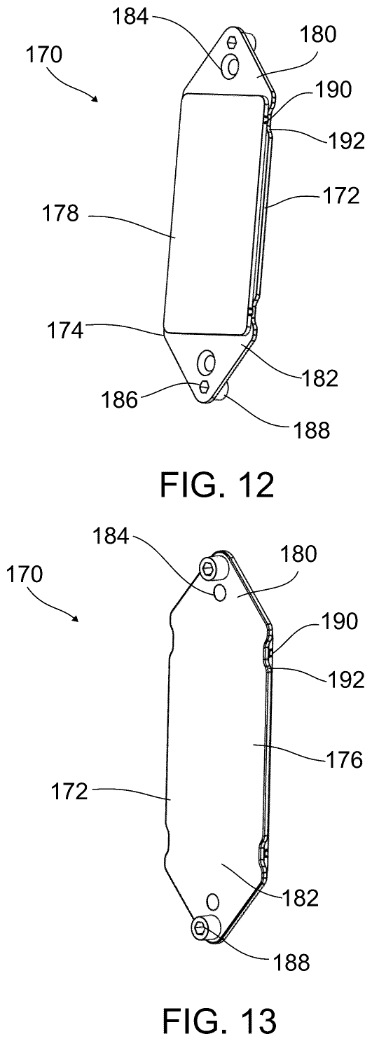

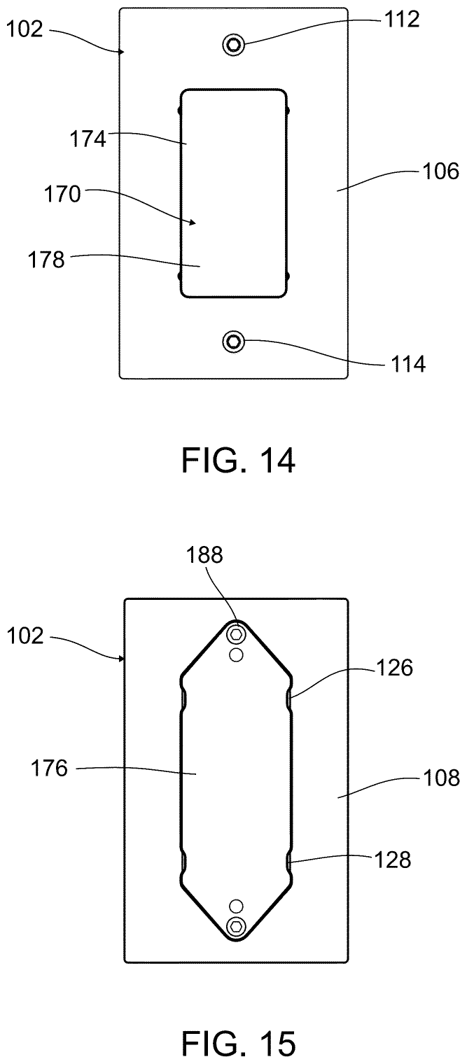

FIGS. 12-15 show an exemplary configuration of an insert 170 that is configured to provide a blank cover plate. Blank cover plates can be used to cover a junction box in locations where an outlet is not currently desired.

The insert 170 can be placed in the central opening 110 of the base 102 and snap-fit to the base 102. The insert 170 includes a body 172 with a first side 174 and a second side 176. When connected to the base 102, the first side 174 of the insert 170 faces the first side 106 of the base 102 and the second side 176 of the insert 170 faces the second side 108 of the base 102.

The first side 174 of the insert 170 includes a raised central area 178. This raised area 178 extends through the central opening 110 of the base 102 so that the first side 174 of the insert 170 is substantially flush with the first side 106 of the base 102.

The body 172 has an upper portion 180 and a lower portion 182 with a substantially planar outer surface. The upper portion 180 and lower portion 182 have angled sides with rounded corners that correspond to the upper and lower recessed areas 118, 120 of the base 102. A first fastener aperture 184 is positioned in each of the upper portion 180 and the lower portion 182. The first fastener apertures 184 can be a counter-sink aperture on the first side 174 configured to receive a standard flat head fastener. The first fastener apertures 184 are positioned to align with mounting features on a standard junction box.

A second fastener aperture 186 is positioned in each of the upper portion 180 and the lower potion 182. The second fastener apertures 186 have a hexagonal configuration and are configured to align with the fastener apertures 112, 114 of the base 102. Fasteners can be inserted into the base fastener apertures 112, 114 and extend through the insert second fastener apertures 186 to secure the base 102 to the insert 170. Bosses 188 extend from the second fastener apertures 186 to provide stability and increased surface area engagement of an inserted fastener.

A set of protrusions 190 are formed on the first side 174 of the insert 170 and a set of indentations 192 are formed in the second side 176 of the insert 170 adjacent the protrusions 190. In the illustrated embodiment two upper and two lower sets of protrusions 190 and indentations 192 are used. The protrusions 190 and indentations 192 are configured to align with the curved recesses 116 and tabs 126, 128 on the base 102 to form a snap-fit connection. Other snap fit structures can also be used, including various cantilever projections and mating components

During installation, the insert 170 can be connected to a junction box with fasteners passing through the first fastener apertures 184. The base 102 is then snap-fit to the insert 170 and connected with fasteners passing through the second fastener apertures 186.

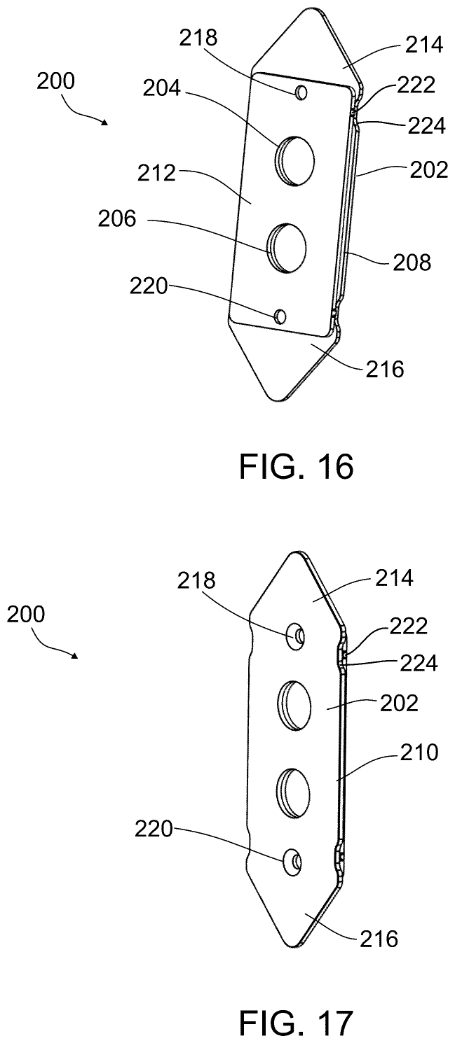

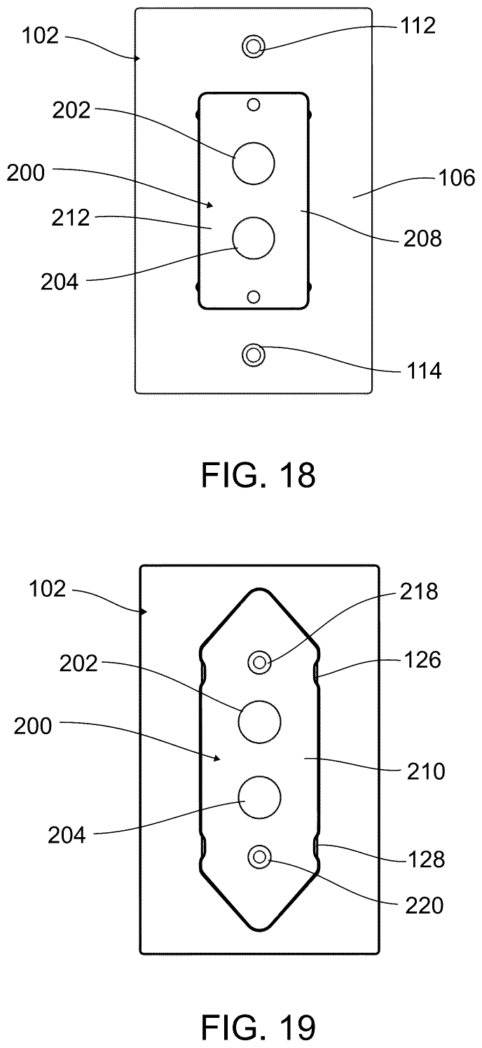

FIGS. 16-19 show an exemplary configuration of an insert 200 that is configured to provide a cover plate for a round two-button switch. Two-button switches can be used in residential or commercial applications to provide an antique switch appearance. Although a round two-button configuration is shown, the insert can be configured to be used with other shapes (e.g., square, rectangular, oblong, etc.) and fewer or more buttons.

The insert 200 has a body 202 with upper and lower openings 204, 206 configured to receive the buttons of the switch. The insert 200 can be placed in the central opening 110 of the base 102 and snap-fit to the base 102. The body 202 of the insert 200 includes a first side 208 and a second side 210. When connected to the base 102, the first side 208 of the insert 200 faces the first side 208 of the base 102 and the second side 210 of the insert 200 faces the second side 108 of the base 102. The insert 200 and base 106 can then be positioned around two-button switch so that the second side 210 of the insert 200 and the second side of the base can then be positioned to face an exterior and the first sides 208, 106 face inwardly toward the junction box.

The first side 208 of the insert 200 includes a raised area 212 around the button openings 204, 206. This raised area 212 extends through the central opening 110 of the base 102 so that the first side 208 of the insert 200 is substantially flush with the first side 106 of the base 102.

The body 202 has an upper portion 214 and a lower portion 216 with a substantially planar outer surface. The upper portion 214 and lower portion 216 have angled sides with rounded corners that correspond to the upper and lower recessed areas 218, 220 of the base 102. An upper fastener aperture 218 is positioned above the upper button opening 204 and a lower fastener opening 220 is positioned below the lower button opening 206. The fastener apertures 218, 220 receive fasteners to connect to a mounting strap on a two-button switch. The fastener apertures can be counter-sink apertures on the second side configured to receive a standard flat head fastener.

A set of protrusions 222 are formed on the first side 208 of the insert 200 and a set of indentations 224 are formed in the second side 210 of the insert 200 adjacent the protrusions 222. In the illustrated embodiment two upper and two lower sets of protrusions 222 and indentations 224 are used. The protrusions 222 and indentations 224 are configured to align with the curved recesses 116 and tabs 126, 128 on the base 102 to form a snap-fit connection. Other snap fit structures can also be used, including various cantilever projections and mating components

During installation, the insert 200 can be snap-fit to the base 102 and connected to a mounting strap of a two-button switch so that the second side 108 of the base 102 and the second side 210 of the insert face 200 outwardly.

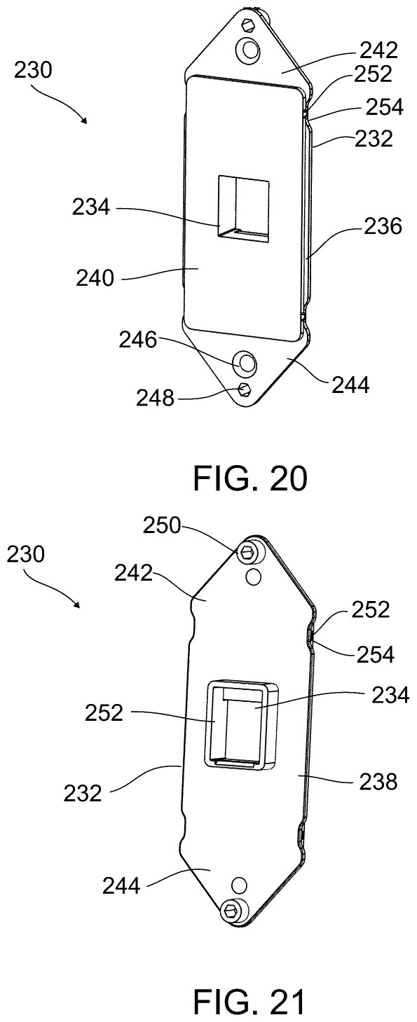

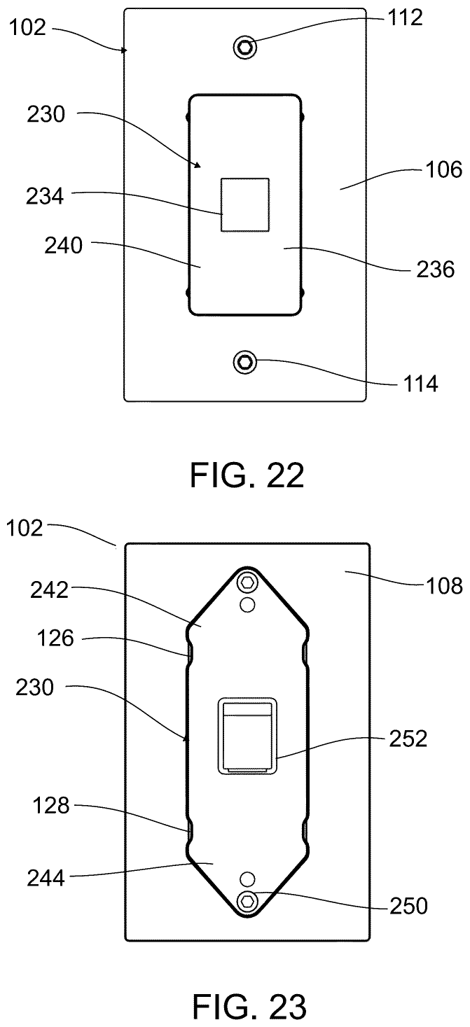

FIGS. 20-23 show an exemplary configuration of an insert 230 that is configured to provide a cover plate for a single port keystone jack. Keystone jacks are modular connectors used in networking and telecommunications applications. They are typically used in residential and commercial applications to provide connectors for Ethernet cables, typically Cat5e, Cat6, or Cat6a cables. Keystone jacks typically have an outer housing with a snap-fit connector to connect to wall plates, patch panels, or other mounting surfaces.

The insert 230 has body 232 with an opening 234 configured to receive the outer housing of a keystone jack. The insert 230 can be placed in the central opening 110 of the base 102 and snap-fit to the base 102. The body 232 of the insert 230 includes a first side 236 and a second side 238. When connected to the base 102, the first side 236 of the insert 230 faces the first side 106 of the base 102 and the second side 238 of the insert 230 faces the second side 108 of the base 102. The insert 230 and base 102 can be positioned around a keystone jack so that the first side 236 of the insert 230 and the first side 106 of the base 102 face an exterior and the second sides 108, 238 face inwardly toward the junction box.

The first side 236 of the insert 230 includes a raised area 240 around the keystone jack opening. This raised area 240 extends through the central opening 110 of the base 102 so that the first side 236 of the insert 230 is substantially flush with the first side 106 of the base 102.

The body 232 of the insert 230 has an upper portion 242 and a lower portion 244 with a substantially planar outer surface. The upper portion and lower portion 242, 244 have angled sides with rounded corners that correspond to the upper and lower recessed areas 118, 120 of the base 102.

First fastener apertures 246 are positioned in the upper and lower portions 242, 246. The first fastener apertures 246 receive fasteners to connect the insert 230 to a mounting feature on a junction box. The first fastener apertures 246 can be counter-sink apertures on the first side 236 configured to receive a standard flat head fastener.

Second fastener apertures 248 are positioned in the upper and lower portions 242, 246. The second fastener apertures 248 have a hexagonal configuration and are configured to align with the fastener apertures 112, 114 of the base 102. Fasteners can be inserted into the base fastener apertures 112, 114 and extend through the insert second fastener apertures 248 to secure the base 102 to the insert 230.

Bosses 250 extend from the second fastener apertures 248 on the second side 238 to provide stability and increased surface area engagement of an inserted fastener. A protrusion 252 can extend from the second side 238 around the opening 234 for receiving the keystone jack.

A set of protrusions 252 are formed on the first side 236 of the insert 230 and a set of indentations 254 are formed in the second side 238 of the insert 230 adjacent the protrusions 252. In the illustrated embodiment two upper and two lower sets of protrusions 252 and indentations 254 are used. The protrusions 252 and indentations 254 are configured to align with the curved recesses 116 and tabs 126, 128 on the base 102 to form a snap-fit connection. Other snap fit structures can also be used, including various cantilever projections and mating components

During installation, the insert 230 can be connected to a junction box with fasteners passing through the first fastener apertures 246. The base 102 is then snap-fit to the insert 230 and secured with fasteners passing through the second fastener apertures 248.

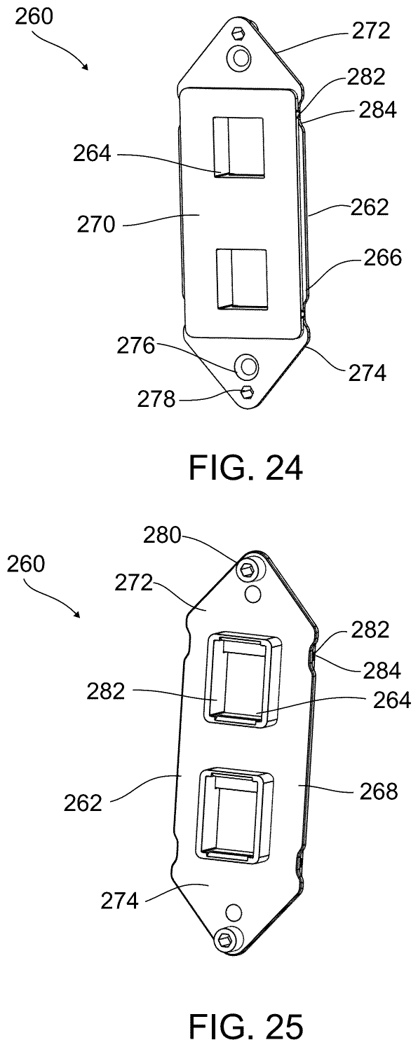

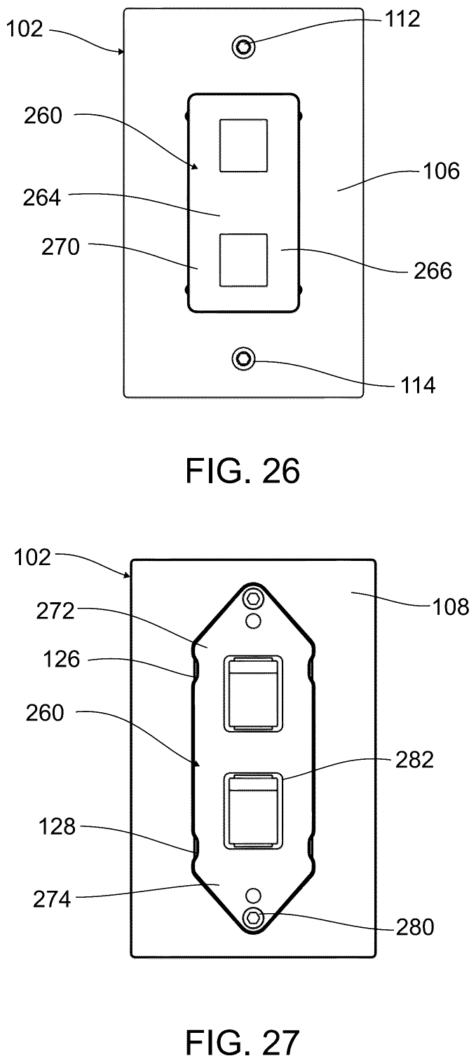

FIGS. 24-27 show an exemplary configuration of an insert 260 that is configured to provide a cover plate for a dual port keystone jack. The insert 260 has body 262 with two openings 264 configured to receive the outer housing of a keystone jack. The insert 260 can be placed in the central opening 110 of the base 102 and snap-fit to the base 102. The body 262 of the insert 260 includes a first side 266 and a second side 268. When connected to the base 102, the first side 266 of the insert 260 faces the first side 106 of the base 102 and the second side 268 of the insert 260 faces the second side 108 of the base 102. The insert 260 and base 102 can be positioned around a pair of keystone jacks so that the first side 266 of the insert 260 and the first side 106 of the base 102 face an exterior and the second sides 108, 268 face inwardly toward the junction box.

The first side 266 of the insert 260 includes a raised area 270 around the keystone jack opening. This raised area 270 extends through the central opening 110 of the base 102 so that the first side 266 of the insert 260 is substantially flush with the first side 106 of the base 102.

The body 262 of the insert 260 has an upper portion 272 and a lower portion 274 with a substantially planar outer surface. The upper portion and lower portion 272, 274 have angled sides with rounded corners that correspond to the upper and lower recessed areas 118, 120 of the base 102.

First fastener apertures 276 are positioned in the upper and lower portions 272, 274. The first fastener apertures 276 receive fasteners to connect the insert 260 to a mounting feature on a junction box. The first fastener apertures 276 can be counter-sink apertures on the first side 276 configured to receive a standard flat head fastener.

Second fastener apertures 278 are positioned in the upper and lower portions 272, 274. The second fastener apertures 278 have a hexagonal configuration and are configured to align with the fastener apertures 112, 114 of the base 102. Fasteners can be inserted into the base fastener apertures 112, 114 and extend through the insert second fastener apertures 278 to secure the base 102 to the insert 260.

Bosses 280 extend from the second fastener apertures 278 on the second side 268 to provide stability and increased surface area engagement of an inserted fastener. A protrusion 282 can extend from the second side 268 around the opening 264 for receiving the keystone jack.

A set of protrusions 282 are formed on the first side 266 of the insert 260 and a set of indentations 284 are formed in the second side 268 of the insert 260 adjacent the protrusions 282. In the illustrated embodiment two upper and two lower sets of protrusions 282 and indentations 284 are used. The protrusions 282 and indentations 284 are configured to align with the curved recesses 116 and tabs 126, 128 on the base 102 to form a snap-fit connection. Other snap fit structures can also be used, including various cantilever projections and mating components

During installation, the insert 260 can be connected to a junction box with fasteners passing through the first fastener apertures 276. The base 102 is then snap-fit to the insert 260 and secured with fasteners passing through the second fastener apertures 278.

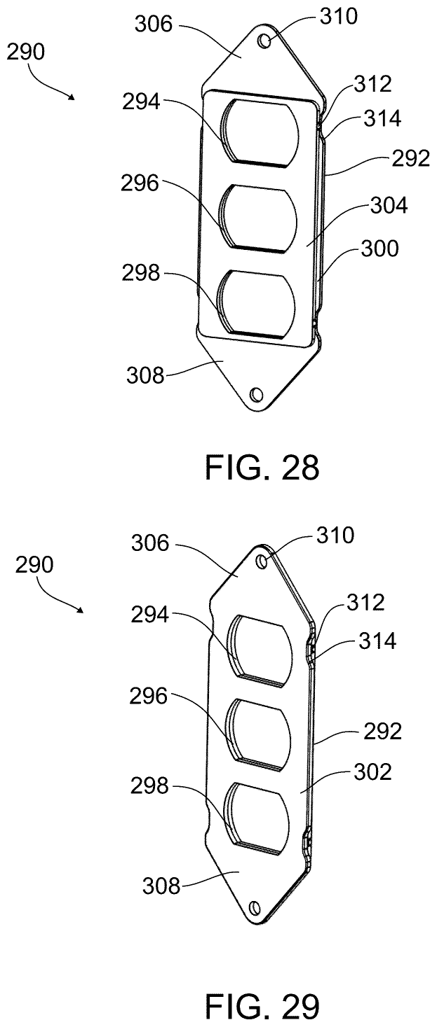

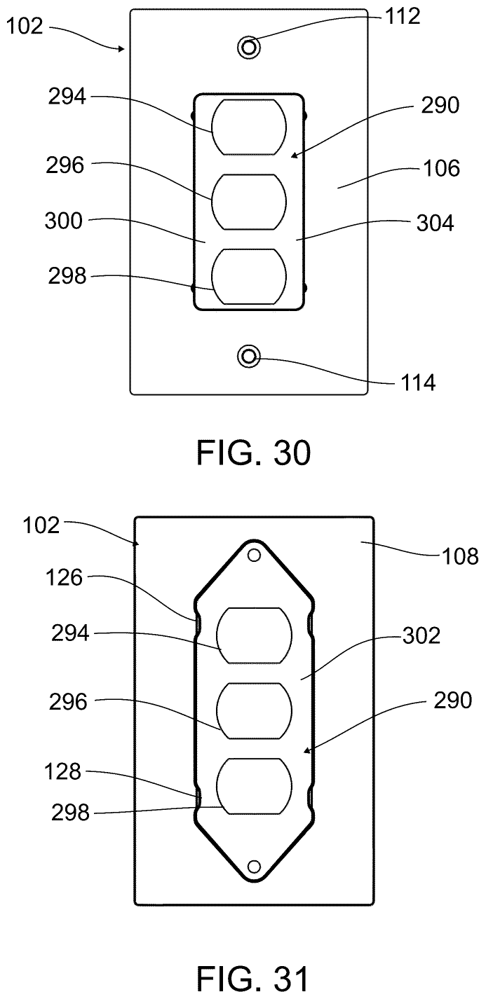

FIGS. 28-31 show an exemplary configuration of an insert 290 that is configured to provide a cover plate for interchangeable devices outlet also known as Despard devices. Despard devices are typically switches and outlets that can be used in different combinations in an outlet housing. For example, any combination of switches and outlets can be assembled in groups of three in a single gang junction box.

The insert 290 has a body 292 with an upper opening 294, a middle opening 296, and a lower opening 298 configured to receive a Despard device. The insert 290 can be placed in the central opening 110 of the base 102 and snap-fit to the base 102. The body 292 of the insert 290 includes a first side 300 and a second side 302. When connected to the base 102, the first side 300 of the insert 290 faces the first side 106 of the base 102 and the second side 302 of the insert 290 faces the second side 108 of the base 102. The insert 290 and base 102 can then be positioned around a set of Despard devices so that the first side of the insert 290 and the first side 106 of the base 102 face an exterior and the second sides 108, 302 face inwardly toward the junction box.

The first side 300 of the insert 290 includes a raised area 304 around the device openings. This raised area 304 extends through the central opening 110 of the base 102 so that the first side 300 of the insert 290 is substantially flush with the first side 106 of the base 102.

The body 292 of the insert 290 has an upper portion 306 and a lower portion 308 with a substantially planar outer surface. The upper portion 306 and lower portion 308 have angled sides with rounded corners that correspond to the upper and lower recessed areas 118, 120 of the base 102. Fastener apertures 310 are positioned in the upper and lower portion 306, 308. The fastener apertures 310 align with the fastener openings 112, 114 on the base 102.

A set of protrusions 312 are formed on the first side 300 of the insert 290 and a set of indentations 314 are formed in the second side 302 of the insert 290 adjacent the protrusions 312. In the illustrated embodiment two upper and two lower sets of protrusions 312 and indentations 314 are used. The protrusions 312 and indentations 314 are configured to align with the curved recesses 116 and tabs 126, 128 on the base 102 to form a snap-fit connection. Other snap fit structures can also be used, including various cantilever projections and mating components

During installation, the insert 290 can be snap-fit to the base 102 and connected to a mounting strap or junction box so that the first side 106 of the base 102 and the first side 300 of the insert 290 face outwardly.

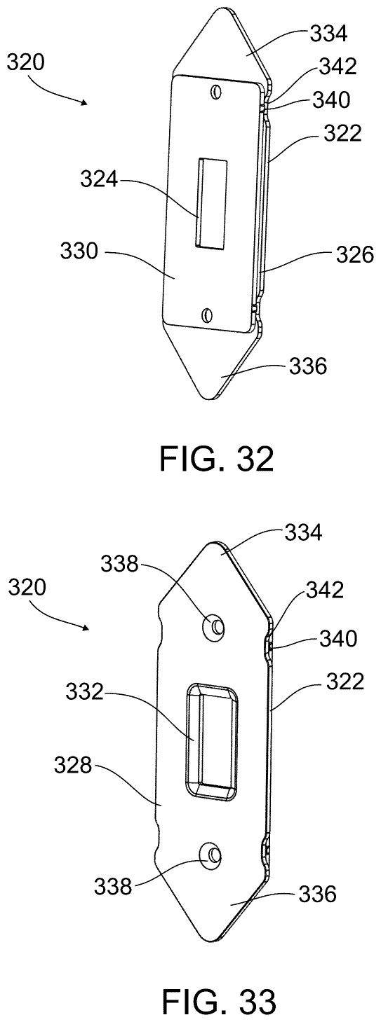

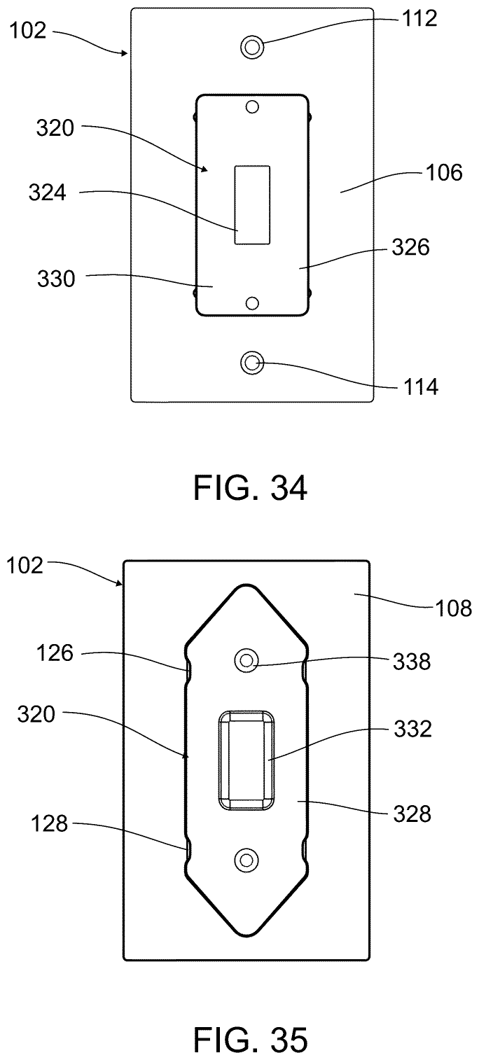

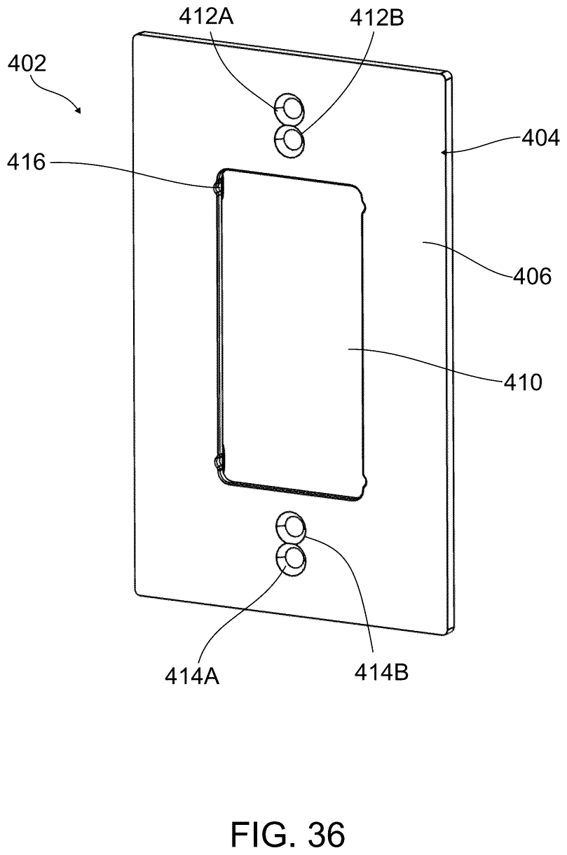

FIGS. 32-35 show an exemplary configuration of an insert 320 that is configured to provide a cover plate for a standard switch. Switches, typically toggle switches, are used to control the flow of electricity to a device. A switch has a toggle which a user can manipulate to open or close an electrical circuit. Standard switches are widely used in homes, offices, and various industrial applications for controlling lights, fans, and other electrical appliances.

The insert 320 has a body 322 with an opening 324 configured to receive the toggle of the switch. The insert 320 can be placed in the central opening 110 of the base 102 and snap-fit to the base 102. The body 322 of the insert 320 includes a first side 326 and a second side 328. When connected to the base 102, the first side 326 of the insert 320 faces the first side 106 of the base 102 and the second side 328 of the insert 320 faces the second side 108 of the base 102. The insert 320 and base 102 can be positioned around a switch so that the second side 328 of the insert 320 and the second side 108 of the base 102 face an exterior and the first sides 106, 326 face inwardly toward the junction box.

The first side 326 of the insert 320 includes a raised area 330 around the toggle opening. This raised area 330 extends through the central opening 110 of the base 102 so that the first side 326 of the insert 320 is substantially flush with the first side 106 of the base 102. The second side 328 of the insert 320 includes a recessed area 332 around the opening 324.

The body 322 of the insert 320 includes an upper portion 334 and a lower portion 336 with a substantially planar outer surface. The upper portion 334 and lower portion 336 have angled sides with rounded corners that correspond to the upper and lower recessed areas of the base. Fastener apertures 338 are positioned in the upper and lower portions 334, 336. The fastener apertures 338 are configured to connect to a mounting strap on the switch. The fastener apertures 338 can be a counter-sink aperture on the second side configured to receive a standard flat head fastener.

A set of protrusions 340 are formed on the first side 326 of the insert 320 and a set of indentations 342 are formed in the second side 328 of the insert 320 adjacent the protrusions 340. In the illustrated embodiment two upper and two lower sets of protrusions 340 and indentations 342 are used. The protrusions 340 and indentations 342 are configured to align with the curved recesses 116 and tabs 126, 128 on the base 102 to form a snap-fit connection. Other snap fit structures can also be used, including various cantilever projections and mating components

During installation, the insert 320 can be snap-fit to the base 102 and connected to a switch so that the second side 108 of the base 102 and the second side 328 of the insert 320 face outwardly.

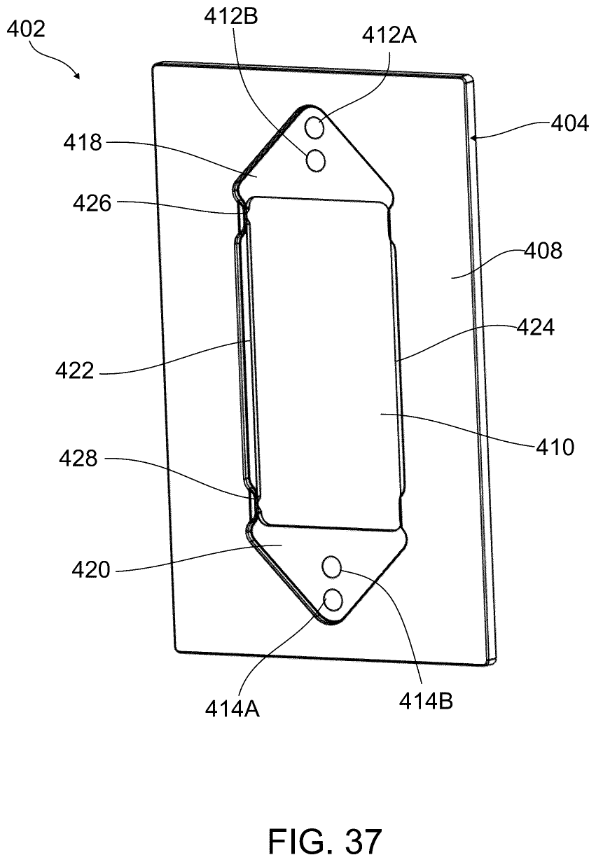

FIGS. 36 and 37 show another exemplary configuration of an adapter having a base plate 402 with a body 404 having a first side 406 and a second side 408. The body 404 has a substantially rectangular configuration that can be sized to fit into a standard single-gang junction box. The size and shape can be varied to accommodate other types of junction boxes, such as two-gang junction boxes, round junction boxes, or other junction boxes. A central opening 410 extends through the body 404 and provides space to receive an electrical device.

In certain configurations, the first side of the body has a substantially flush face surrounding the central opening 410. A pair of upper fastener apertures 412A, 412B and a pair of lower fastener apertures 414A, 414B extend through the body 402 on opposite side of the central opening 410. The fastener apertures 412A, 412B, 414A, 414B can have a countersink configuration to accommodate a standard flat type screw head. From the first side 406, the central opening 410 is configured to receive a GFCI outlet.

The first side 406 of the body 404 around the central opening 410 can include one or more curved recesses 416. For example, two curved recess 416 can be provided on each long side of the opening 410, positioned toward the top and bottom of the opening 410.

In certain configurations, the second side 408 includes a substantially flush outer portion. An upper recessed area 418 and lower recessed area 420 and a pair of side recessed areas 422, 424 are formed around the central opening 410. The upper and lower recessed areas 418, 420 have angled sides with rounded corners, with the upper and lower corners being formed around the fastener apertures 412A, 412B, 414A, 414B. The side corners extend around the corners of the central opening 410. The side recessed areas 422, 424 extend between the upper and lower recessed areas 418, 420.

A set of upper tabs 426 and lower tabs 428 separate the side recessed areas 422, 424 from the upper and lower recessed areas 418, 420. The tabs 426, 428 and the curved recesses 416 form a snap-fit connection with a corresponding insert when connected to the base 402. Other snap fit structures can also be used, including various cantilever projections and mating components

The additional fastener apertures are configured to accommodate installation of an electrical device and the base 402 simultaneously. For example, the inner apertures 412B, 414B can align with the mounting hole openings on an electrical device, such as the GFCI 130, that connect to the junction box. In this way, the electrical device can be positioned in the base and installed into the junction box in a single operation instead of securing the device to the junction box and securing the base 402 to the device.

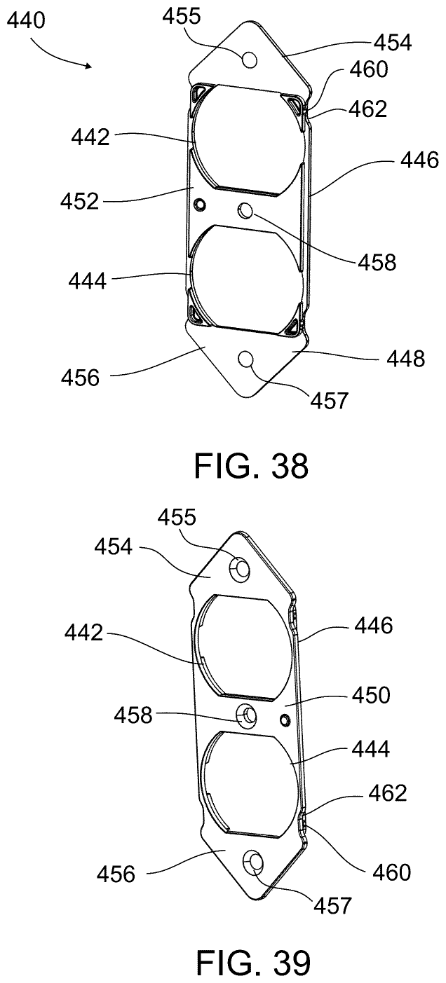

FIGS. 38 and 39 show an exemplary configuration of an insert 440 that is configured to provide a cover plate for a standard duplex outlet. The insert 440 can be used with any of the illustrated bases or with other base configurations as would be understood by one of ordinary skill in the art. The insert 440 has upper and lower openings 442, 444 configured to receive the protruding receptacle faces of a standard duplex outlet. The insert 440 can be placed in the central opening 410 and snap-fit to the base 402. The insert 440 includes a body 446 with a first side 448 and a second side 450. When connected to the base 402, the first side 448 of the insert 440 faces the first side 406 of the base 402 and the second side 450 of the insert 440 faces the second side 408 of the base 402. The insert 440 and base 402 can then be positioned around a duplex outlet so that the second side 450 of the insert 440 and the second side 408 of the base 402 are positioned to face an exterior and the first sides 406, 448 face inwardly toward the junction box.

The first side 448 of the insert 440 includes a raised area 452 around the receptacle openings 442, 444. This raised area 452 extends through the central opening 410 of the base 402 so that the first side 448 of the insert 440 is substantially flush with the first side 406 of the base 402. The raised area 452 can include upper and lower raised corners on each side of the receptacle openings 442, 444 and a central raised area between the receptacle openings 442, 444.

The first side 448 and the second side 450 have an upper portion 454 and a lower portion 456 with a substantially planar outer surface. The upper portion 454 and lower portion 456 have angled sides with rounded corners that correspond to the upper and lower recessed areas 418, 420 of the base 402. An upper fastener aperture 455 is provided in the upper portion 454 and a lower fastener aperture 457 is provided in the lower portion 456. A central fastener aperture 458 is positioned between the upper and lower receptacle openings 442, 444 to receive a fastener to connect to a standard duplex receptacle. The fastener apertures 455, 457, 458 can be a counter-sink aperture on the second side 450 configured to receive a standard flat head fastener.

A set of protrusions 460 are formed on the first side 448 of the insert 440 and a set of indentations 462 are formed in the second side 450 of the insert 440 adjacent the protrusions 460. In the illustrated embodiment two upper and two lower sets of protrusions 460 and indentations 462 are used. The protrusions 460 and indentations 462 are configured to align with the curved recesses 416 and tabs 426, 428 on the base 402 to form a snap-fit connection. Other snap fit structures can also be used, including various cantilever projections and mating components

During installation, the upper fastener aperture 455 and the lower fastener aperture 457 can align with the base inner apertures 412B, 414B, which can align with mounting hole openings on an electrical device that connect to the junction box. In this way, the electrical device can be positioned in the insert 440 and the base 402 and installed into the junction box in a single operation instead of securing the device to the junction box and securing the base 402 and insert 440 to the device.

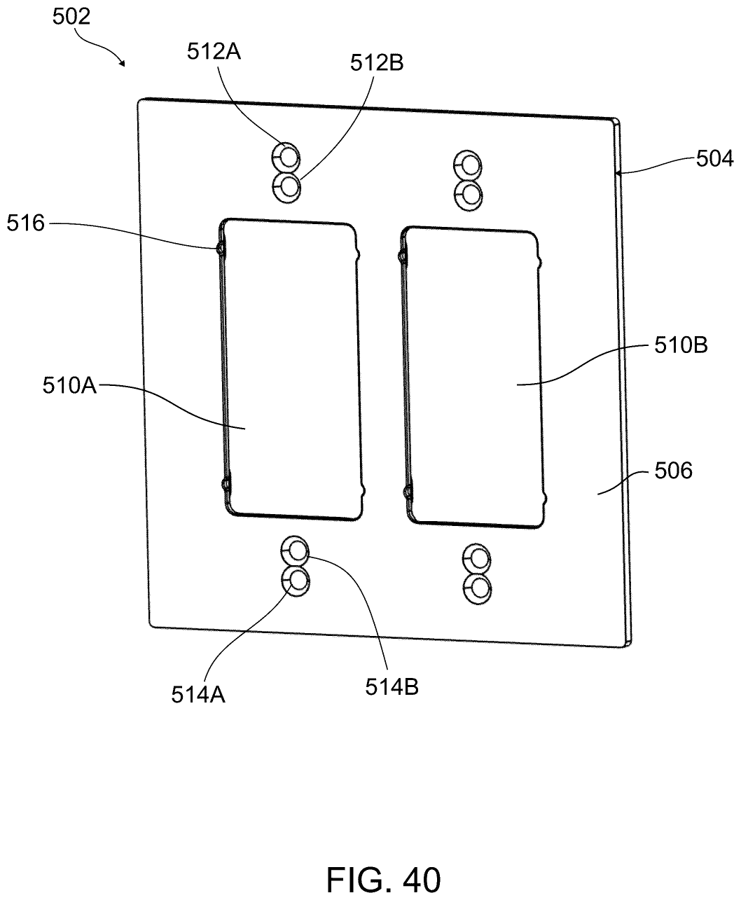

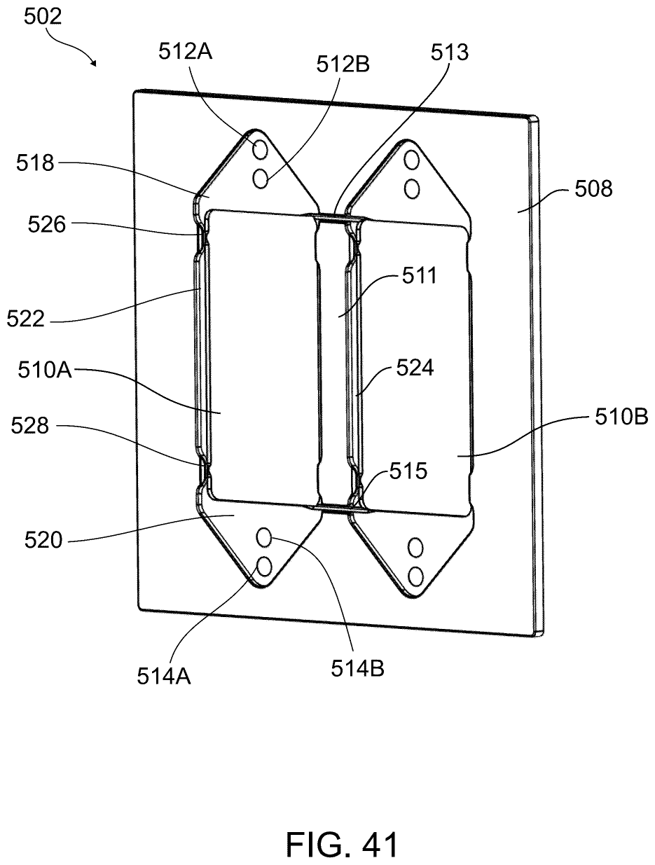

FIGS. 40 and 41 show an exemplary configuration of a two-gang adapter having a base plate 502 with a body 504 having a first side 506 and a second side 508. The body 504 has a substantially rectangular configuration that can be sized to fit into a standard two-gang junction box. The size and shape can be varied to accommodate other types of junction boxes, such as two-gang junction boxes, round junction boxes, or other junction boxes. A first opening 510A and a second opening 510B extend through the body 504 and provides space to receive an electrical device. The first opening 510A and the second opening 510B are separated by a divider 511.

In certain configurations, the first side of the body has a substantially flush face surrounding the central openings 510A, 510B. A pair of upper fastener apertures 512A, 512B and a pair of lower fastener apertures 514A, 514B extend through the body 502 on opposite side of the central openings 510A, 510B. The fastener apertures 512A, 512B, 514A, 514B can have a countersink configuration to accommodate a standard flat type screw head.

On the first side 506 of the body 504, around the central openings 510A, 510B, can include one or more curved recesses 516. For example, two curved recess 516 can be provided on each long side of the openings 510A, 510B, positioned toward the top and bottom of the openings 510A, 510B.

In certain configurations, the second side 508 includes a substantially flush outer portion. An upper recessed area 518 and lower recessed area 520 and a pair of side recessed areas 522, 524 are formed around each opening 510A, 510B. The upper and lower recessed areas 518, 520 have angled sides with rounded corners, with the upper and lower corners being formed around the fastener apertures 512A, 512B, 514A, 514B. The side recessed areas 522, 524 extend between the upper and lower recessed areas 518, 520. A set of upper tabs 426 and lower tabs 428 extend into the side recessed areas 522, 524. The tabs 526, 528 and the curved recesses 516 form a snap-fit connection with a corresponding insert when connected to the base 502. Other snap fit structures can also be used, including various cantilever projections and mating components

During installation, the base 502 can be used with two separate electrical devices or the divider 511 can be removed to allow for insertion of a single device. The divider 511 can be connected to the body 504 using one or more frangible connections. For example, upper and lower score lines 513, 515 can be used so that the divider 511 can be removed by a user as needed. Other types of frangible connections, including perforations and other weakened areas can be used. When the divider 511 is removed, an adapter plate spanning both openings 510A, 510B can be connected to the base 502 to cover an electrical device.

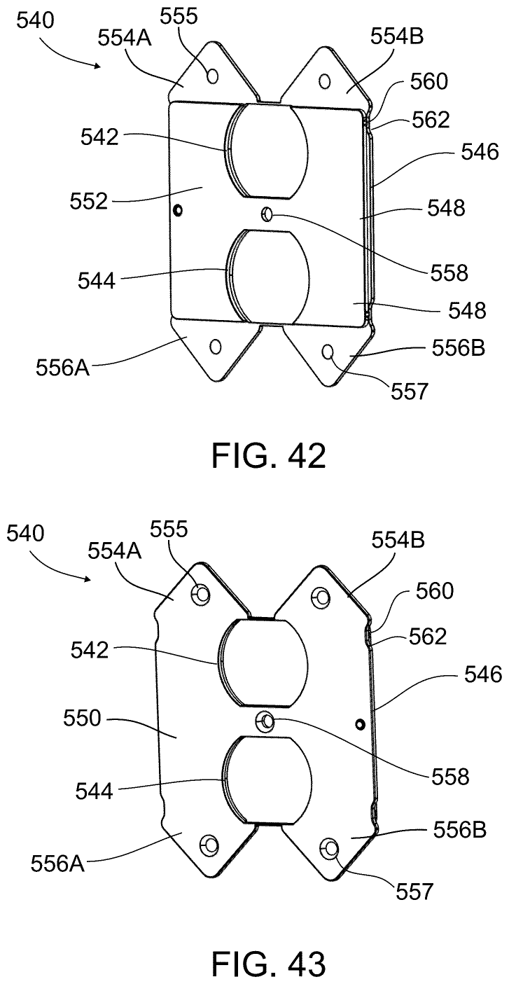

FIGS. 42 and 43 show an exemplary configuration of an insert 540 that is configured to provide a cover plate for a standard duplex outlet used with the two-gang base 502 or other two-gang base configurations. The insert 540 has upper and lower openings 542, 544 configured to receive the protruding receptacle faces of a standard duplex outlet. The insert 540 can be placed into the base 502 after removal of the divider 511 and snap-fit to the base 502. The insert 540 includes a body 546 with a first side 548 and a second side 550. When connected to the base 502, the first side 548 of the insert 540 faces the first side 506 of the base 502 and the second side 550 of the insert 540 faces the second side 508 of the base 502. The insert 540 and base 502 can then be positioned around a duplex outlet so that the second side 550 of the insert 540 and the second side 508 of the base 502 are positioned to face an exterior and the first sides 506, 548 face inwardly toward the junction box.

The first side 548 of the insert 540 includes a raised area 552 around the receptacle openings 542, 544. This raised area 552 extends through the central opening of the base 502 so that the first side 548 of the insert 540 is substantially flush with the first side 506 of the base 502.

The first side 548 and the second side 550 have a pair of upper portions 554A, 554B and a pair of lower portions 556A, 556B with a substantially planar outer surface.

The upper portions 554A, 554B and lower portion 556A, 556B have angled sides with rounded corners that correspond to the upper and lower recessed areas 518, 520 of the base 502. An upper fastener aperture 555 is provided in each of the upper portion 554A, 554B and a lower fastener aperture 557 is provided in the lower portion 556A, 556B. A central fastener aperture 558 is positioned between the upper and lower receptacle openings 542, 544 to receive a fastener to connect to a standard duplex receptacle. The fastener apertures 555, 557, 558 can be a counter-sink aperture on the second side 550 configured to receive a standard flat head fastener.

A set of protrusions 560 are formed on the first side 548 of the insert 540 and a set of indentations 562 are formed in the second side 550 of the insert 540 adjacent the protrusions 560. In the illustrated embodiment two upper and two lower sets of protrusions 560 and indentations 562 are used. The protrusions 560 and indentations 562 are configured to align with the curved recesses 516 and tabs 526, 528 on the base 502 to form a snap-fit connection. Other snap fit structures can also be used, including various cantilever projections and mating components.

During installation, the upper fastener aperture 555 and the lower fastener aperture 557 can align with the base inner apertures 512B, 514B, which can align with mounting hole openings on an electrical device that connect to the junction box. In this way, the electrical device can be positioned in the insert 540 and the base 502 and installed into the junction box in a single operation instead of securing the device to the junction box and securing the base 502 and insert 540 to the device.

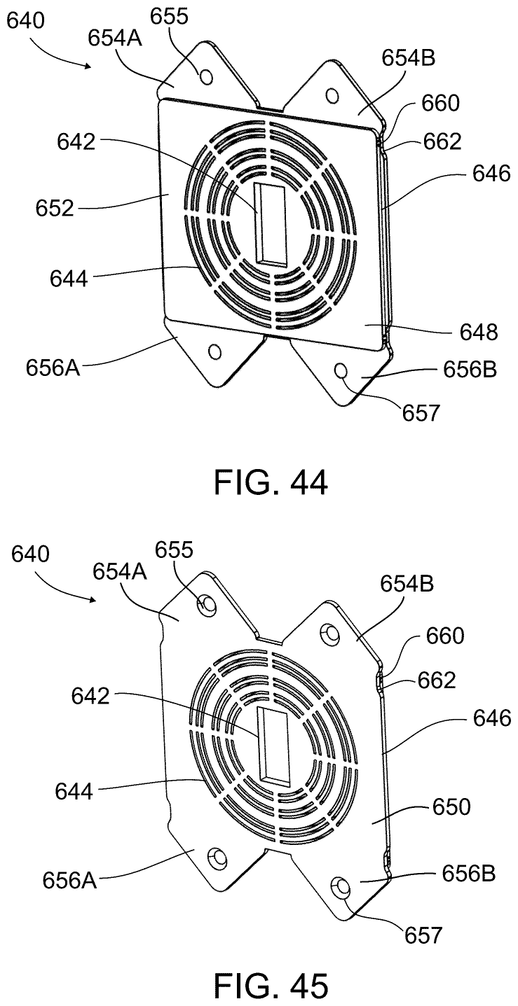

FIGS. 44 and 45 show an exemplary configuration of an insert 640 that is configured to provide a cover plate for either a round, flanged outlet or a standard toggle switch that can used with the two-gang base 502 or other two-gang base configurations. The insert 640 has a central switch opening 642 and a plurality of concentric rings 644. The rings 644 act as knock-outs that can be removed to receive a flanged outlet. The different corresponding rings 644 can correspond to different standard size round outlets, for example NEMA standard sized flanged outlets.

The insert 640 can be placed into the base 502 after removal of the divider 511 and after removal of any of the interior rings 644 as needed, and snap-fit to the base 502. The insert 640 includes a body 646 with a first side 648 and a second side 650. When connected to the base 502, the first side 648 of the insert 640 faces the first side 506 of the base 502 and the second side 650 of the insert 640 faces the second side 508 of the base 502. The insert 640 and base 502 can then be positioned around a device so that the second side 650 of the insert 640 and the second side 508 of the base 502 are positioned to face an exterior and the first sides 506, 648 face inwardly toward the junction box.

The first side 648 of the insert 640 includes a raised area 652. This raised area 652 extends through the central opening of the base 502 so that the first side 648 of the insert 640 is substantially flush with the first side 506 of the base 502.

The first side 648 and the second side 650 have a pair of upper portions 654A, 654B and a pair of lower portions 656A, 656B with a substantially planar outer surface. The upper portions 654A, 654B and lower portion 656A, 656B have angled sides with rounded corners that correspond to the upper and lower recessed areas 518, 520 of the base 502. An upper fastener aperture 655 is provided in each of the upper portion 654A, 654B and a lower fastener aperture 657 is provided in the lower portion 656A, 656B. The fastener apertures 655, 657 can be a counter-sink aperture on the second side 650 configured to receive a standard flat head fastener.

A set of protrusions 660 are formed on the first side 648 of the insert 640 and a set of indentations 662 are formed in the second side 650 of the insert 640 adjacent the protrusions 660. In the illustrated embodiment two upper and two lower sets of protrusions 660 and indentations 662 are used. The protrusions 660 and indentations 662 are configured to align with the curved recesses 516 and tabs 526, 528 on the base 502 to form a snap-fit connection. Other snap fit structures can also be used, including various cantilever projections ad mating components.

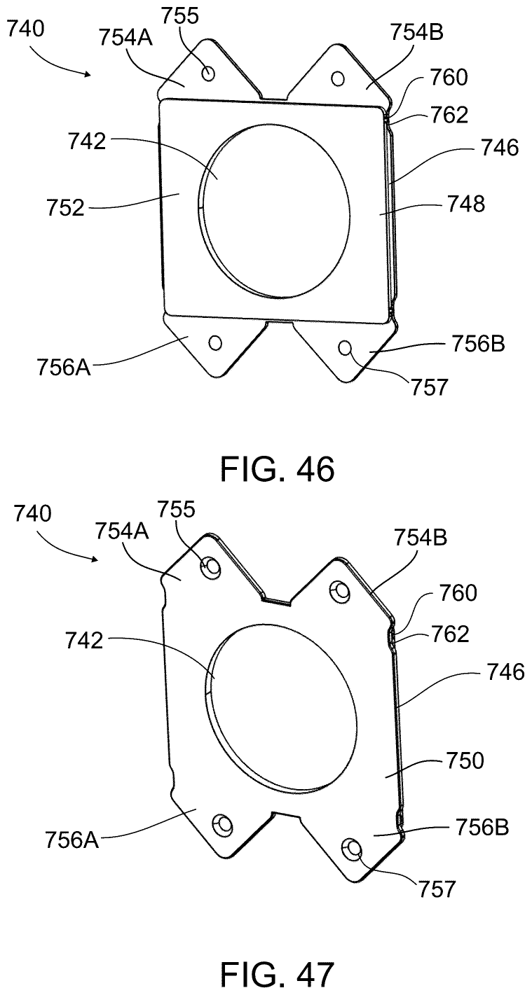

FIGS. 46 and 47 show an exemplary configuration of an insert 740 that is configured to provide a cover plate for a round, flanged outlet that can used with the two- gang base 502 or other two-gang base configurations. The insert 740 has a central opening 742 configured to receive a flanged outlet. The size of the opening 742 can vary to correspond to different standard size round outlets, for example NEMA standard sized flanged outlets.

The insert 740 can be placed into the base 502 after removal of the divider 511 and after removal of any of the interior rings 744 as needed, and snap-fit to the base 502. The insert 740 includes a body 746 with a first side 748 and a second side 750. When connected to the base 502, the first side 748 of the insert 740 faces the first side 506 of the base 502 and the second side 750 of the insert 740 faces the second side 508 of the base 502. The insert 740 and base 502 can then be positioned around a device so that the second side 750 of the insert 740 and the second side 508 of the base 502 are positioned to face an exterior and the first sides 506, 748 face inwardly toward the junction box.

The first side 748 of the insert 740 includes a raised area 752. This raised area 752 extends through the central opening of the base 502 so that the first side 748 of the insert 740 is substantially flush with the first side 506 of the base 502.

The first side 748 and the second side 750 have a pair of upper portions 754A, 754B and a pair of lower portions 756A, 756B with a substantially planar outer surface. The upper portions 754A, 754B and lower portion 756A, 756B have angled sides with rounded corners that correspond to the upper and lower recessed areas 518, 520 of the base 502. An upper fastener aperture 755 is provided in each of the upper portion 754A, 754B and a lower fastener aperture 757 is provided in the lower portion 756A, 756B. The fastener apertures 755, 757 can be a counter-sink aperture on the second side 750 configured to receive a standard flat head fastener.

A set of protrusions 760 are formed on the first side 748 of the insert 740 and a set of indentations 762 are formed in the second side 750 of the insert 740 adjacent the protrusions 760. In the illustrated embodiment two upper and two lower sets of protrusions 760 and indentations 762 are used. The protrusions 760 and indentations 762 are configured to align with the curved recesses 516 and tabs 526, 528 on the base 502 to form a snap-fit connection. Other snap fit structures can also be used, including various cantilever projections ad mating components.

Other configurations of inserts can be used for any electrical device as described herein. In the illustrated embodiments, the outer surfaces of the inserts are substantially flush with the outer surfaces of the base, given standard manufacturing tolerances. In other configurations, the outer faces of the inserts can be recessed or extend from the outer faces of the base in any combination.

The foregoing detailed description of the certain exemplary configurations and implementations has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. An adapter plate for an electrical box comprising:
a base including a base body having a first side and a second side, wherein the base body defines an opening configured to receive an electrical device, and wherein the base includes a first snap-fit connector adjacent the opening; and
an insert including an insert body configured to mate with the base, the insert body having a device opening and a second snap-fit connector configured to engage with the first snap-fit connector to releasably secure the insert to the base,
wherein the second side includes an upper recess and a lower recess configured to receive at least a portion of the insert.

2. The adapter plate of claim 1, wherein the first snap-fit connector includes a tab extending into the central opening.

3. The adapter plate of claim 2, wherein the second snap-fit connector includes a protrusion configured to engage the tab.

4. The adapter plate of claim 1, wherein the opening is sized to receive a GFCI outlet.

5. The adapter plate of claim 1, wherein an outer surface of the insert is substantially flush with an outer surface of the base when the insert is mated with the base.

6. The adapter plate of claim 1, wherein the first side is configured to face an exterior when the base is directly connected to a mounting strap or junction box and wherein the second side is configured to face the exterior when the insert is directly connected to a mounting strap or junction box.

7. The adapter plate of claim 6, wherein the first side is configured to face an exterior when the insert is directly connected to a junction box and the base is directly connected to the insert.

8. The adapter plate of claim 1, wherein the base includes a second opening configured to receive a second electrical device and a second insert and the base includes a removable divider between the opening and the second opening.

9. The adapter plate of claim 1, wherein the base body includes a first upper fastener aperture, a second upper fastener aperture, a first lower fastener aperture, and a second lower fastener aperture, wherein the first upper fastener aperture is configured to align with an upper mounting opening on an electrical device and an upper mounting opening on a junction box, and wherein the first lower fastener aperture is configured to align with a lower mounting opening on an electrical device and a lower mounting opening on a junction box.

10. An electrical box assembly comprising:
a junction box having a rear wall and a plurality of side walls extending from the rear wall to define an interior;
an electrical device connected to the junction box, wherein the electrical device is connected to a power supply by an electrical connection positioned inside the interior of the junction box;
an adapter plate having a base and an insert, the base including a base body having a first side and a second side, wherein the base body defines an opening configured to receive an electrical device and an insert, and wherein the base includes a first snap-fit connector adjacent the opening configured to releasably connect the insert to the base the insert including an insert body configured to mate with the base, the insert body having a device opening and a second snap-fit connector configured to engage with the first snap-fit connector.

11. The electrical box assembly of claim 10, wherein the second side includes an upper recess and a lower recess configured to receive at least a portion of the insert.

12. The electrical box assembly of claim 10, wherein the first snap-fit connector includes a tab extending into the central opening.

13. The electrical box assembly of claim 10, wherein the second snap-fit connector includes a protrusion configured to engage the tab.

14. The electrical box assembly of claim 13, wherein the base body includes an upper fastener aperture and a lower fastener aperture.

15. The electrical box assembly of claim 10, wherein the insert is one of a plurality of inserts.

16. The electrical box assembly of claim 10, wherein the device opening is configured to receive one of a duplex outlet face, a keystone jack, a switch, or a Despard device.

17. The electrical box assembly of claim 10, wherein the first side is configured to face an exterior when the base is directly connected to a mounting strap or junction box and wherein the second side is configured to face the exterior when the insert is directly connected to a mounting strap or junction box.

18. The electrical box assembly of claim 17, wherein the first side is configured to face an exterior when the insert is directly connected to a junction box and the base is directly connected to the insert.

19. A method of installing an electrical device comprising:
electrically connecting an electrical device to a power supply via an electrical connection;
positioning the electrical connection inside of a junction box;
mechanically connecting the electrical device to the junction box;
selecting an insert configured for the electrical device and connecting the insert to a base plate to form an adapter plate; and
connecting the adapter plate to the electrical device.

20. The method of claim 19, wherein the electrical device includes a mounting strap and the adapter plate is connected to the mounting strap.
